(19) United States
(12) Patent Application Publication
(10) Pub. No.: US 2020/0258669 A1
(43) Pub. Date: Aug. 13, 2020

(54) METHOD FOR SERVICING A TRANSFORMER AND TRANSFORMER ARRANGEMENT

(71) Applicant: Siemens Gamesa Renewable Energy A/S, Brande (DK)

(72) Inventor: Lasse Jensen, Varde (DK)

(21) Appl. No.: 16/637,859

(22) PCT Filed: Aug. 9, 2018
(86) PCT No.: PCT/EP2018/071595

§ 371 Date: Feb. 10, 2020

(30) Foreign Application Priority Data
Aug. 17, 2017 (DE) 10 2017 214 345.2

(51) Int. Cl. H01F 27/00; F03D 80/50; F03D 13/10; H01F 27/02; H01F 27/06; H01F 27/12; H01F 27/28

(52) U.S. Cl. CPC H01F 27/004; F03D 80/50; F03D 13/10; F05B 2230/61; H01F 27/06; H01F 27/12; H01F 27/28; H01F 27/025

(57) ABSTRACT

Provided is a method for servicing a transformer, especially a transformer of a wind turbine, wherein a lifting device is used to lift a lid that closes a case of a transformer from the case to expose at least one electrical component of the transformer that is connected to the lid for exchanging or servicing the electrical component, wherein the lifting device includes at least one fixed component that is fixed with respect to the case and at least one moveable component that is coupled to the lid, wherein the moveable component is moveable with respect to the fixed component by at least one actuator to lift the lid.

### CROSS-REFERENCE TO RELATED APPLICATIONS

This application claims priority to PCT Application No. PCT/EP2018/071595, having a filing date of Aug. 9, 2018, which is based on German Application No. 10 2017 214 345.2, having a filing date of Aug. 17, 2017, the entire contents both of which are hereby incorporated by reference.

### FIELD OF TECHNOLOGY

The following concerns a method for servicing a transformer, especially a transformer of a wind turbine. The following also concerns a transformer arrangement.

### BACKGROUND

Wind turbines, e.g. offshore wind turbines, use high performance transformers for power conditioning. These high performance transformers are typically placed within a case that can e.g. be used for oil cooling the transformer. The windings of the transformer are connected to the outside of the case by so-called bushing rods. These are rods that are made from metal, e.g. copper, and that are connected to a respective winding on the inner side of the rod and that pass through the case. If a conductive case is used a bushing or isolation can be used that is arranged between the bushing rod and the case.

The bushing rods on the high- and/or low-voltage side of the transformer can be damaged, e.g. when the wind turbine is hit by lightning. This is especially problematic, when the transformers used in an offshore wind turbine, since typically the whole transformer or container that houses the transformer needs to be shipped to the shore to be repaired. On-site repairs are typically not possible, since it would be necessary to disassemble the case of the transformer to reach the bushing rods.

### SUMMARY

An aspect relates to an improved method for servicing a transformer, that allows to exchange or service at least some parts of the transformer on-site without dismounting the transformer.

This problem is solved by a method for servicing a transformer, especially a transformer of a wind turbine, wherein a lifting devices is used to lift a lid that closes a case of a transformer from the case to expose at least one electrical component of the transformer that is connected to the lid for exchanging or servicing the electrical component, wherein the lifting device comprises at least one fixed component that is fixed with respect to the case and at least one movable component that is coupled to the lid, wherein the movable component is movable with respect to the fixed component by at least one actuator to lift the lid.

The proposed method allows for access to the components of the transformer without dismounting the case. Direct access to the relevant component can be achieved on-site, and changing or servicing the electrical component can therefore be achieved without dismounting the transformer form its normal usage position. Therefore, the downtime of the transformer and therefore of the wind turbine as well as the workload created for exchanging or servicing the component can be reduced.

The lid can be moved linearly with respect to the case when the movable component is moved. In this case components attached to the lid keep their distance to the side walls of the case. The movable component is moved linearly with respect to the fixed component. This can be achieved directly by using a linear actuator or by using a transmission to convert, e.g. a circular motion of an actuator to a linear movement. The actuator can be an electrical actuator that converts electrical control signals into movement. Alternatively, or additionally hydraulical or mechanical actuators can be used to cause the movement of the movable component with respect to the fixed component.

Additionally, to the electrical component to be serviced or exchanged, e.g. the bushing rod, additional components, e.g. the transformer core or at least one of the windings can be attached to the lid to ensure mechanical stability when the lid is lifted from the case. This is especially advantageous when a bushing rod that should be exchanged is weakened by damage caused to the bushing rod, e.g. by lightning.

A conductive connecting element, e.g. a bushing rod, that is electrically connected to a respective winding of the transformer and passes through the lid can be replaced as the electrical component. The connecting element can especially be coupled to the lid via an isolation element, e.g. a bushing.

The lifting device can comprise at least one telescopic bar, wherein the lid is lifted by extending the telescopic bar via the actuator. Multiple, e.g. four, telescopic bars and respective actuators are arranged around the case to lift the lid from several sides of the case. The telescopic bars comprises a fixed bar that is fixed with respect to the case and the movable bar that is directly or indirectly connected to the lid. When the movable bar is moved with respect to the fixed bar the lid is pushed up.

The at least one moveable component can be, comprise or form a lift frame that is coupled to the lid at at least two separate positions. Such a lift frame can also be called lifting yoke. The lift frame can have a rectangular shape and be e.g. formed by four orthogonal bars.

The lifting device can comprise at least two or three of the telescopic bars, wherein the lift frame is connected to all the telescopic bars, especially to the movable bars of the telescopic bars. The connection to the telescopic bars can especially be at the corners or close to the corners of the lifting frame. The fixed bars can be arranged around the case and attached to the case or to a common carrying structure. The telescopic bars can be arranged such that they extend in the direction that the lid is lifted off the case. Using a lid that is placed on top of a case that is lifted upward is advantageous when the case is used to house coolant, e.g. oil. The coolant does not need to be removed from the case in this case to service or exchange the electrical component.

The lid can be lifted until the distance between the lid and the case is at least 200 mm, may be at least 300 mm. In this case the height is typically sufficient to reach the relevant electrical components and to be able to service and/or exchange them.

The lid can be locked into position after lifting the lid by a lock or locking means. Additionally, or alternatively at least one blocking element, may be two or three blocking elements, can be placed between the lid and the case before the electrical component is exchanged or serviced. Both approaches allow to secure the lid in a raised position, even when a relatively simple lifting mechanism is used. An unintentionally dropping of the lid needs to be avoided, since service personal might be working under the lid. At the same time the discussed approaches for securing the lid can be implemented very simply and cost effective and avoid needing, e.g. a redundancy layer within the lifting device to secure the lid. The gap between the lid and the case can be at least partially covered by a cover or a tarpaulin before the electrical component is exchanged or serviced. This cover or tarpaulin can be mounted between the lid and the case which can, e.g. be an oil-tub. This can help to avoid a dropping of dirt or objects inside the transformer. This allows to safely work around and underneath the lid without risking a contamination of the coolant, e.g. of the transformer oil.

Embodiments of the invention also concern a transformer arrangement, especially a transformer arrangement for a wind turbine, comprising a transformer that comprises a case, a lid that closes the case and at least one electrical component that is connected to the lid, wherein the arrangement also comprises a lifting device to lift the lid with respect to the case to expose the electrical component for exchanging or servicing the electrical component, wherein the lifting device comprises at least one fixed component that is fixed with respect to the case and at least one movable component which is coupled to the lid, wherein the moveable component is movable with respect to the fixed component by at least one actuator to lift the lid. The transformer arrangement, especially the lifting device, can comprise a control unit that can control the actuator. The control unit controls multiple actuators to allow for coordinated operation of the actuators. E.g. multiple telescopic bars can be extended in unison to ensure an even lifting of the lid. The electrical component can be a bushing rod, a bushing, the core or a winding of the transformer.

The transformer can comprise a transformer core with at least two windings and at least one connecting element that is conductively connected to a respective winding and that extends through the lid. The connecting element can be the exposed component that is to be exchanged and/or serviced. The connecting element can be coupled to the lid via an isolation element, e.g. a bushing.

The at least one movable component can be, comprise or form a lift frame that is coupled to the lid at at least two separate positions. The lifting device can comprise at least one telescopic bar, wherein the lid is lifted by extending the telescopic bar via the actuator. The lifting device comprises at least two or three of the telescopic bars, wherein the lift frame is connected to a respective movable component of the telescopic bars. The telescopic bars are distributed along a circumference of the case, especially at the corners of the case. The fixed components of the telescopic bars can be attached to the case or both the fixed components and the case can be connected to a common carrying structure. The carrying structure can, e.g. be a container in which the transformer is arranged or any other component of the wind turbine, e.g. a platform of the wind turbine.

The features discussed with respect to the inventive method can be transferred to the inventive transformer is arrangement and vice versa with all discussed advantages.

### BRIEF DESCRIPTION

Some of the embodiments will be described in detail, with reference to the following figures, wherein like designations denote like members, wherein:

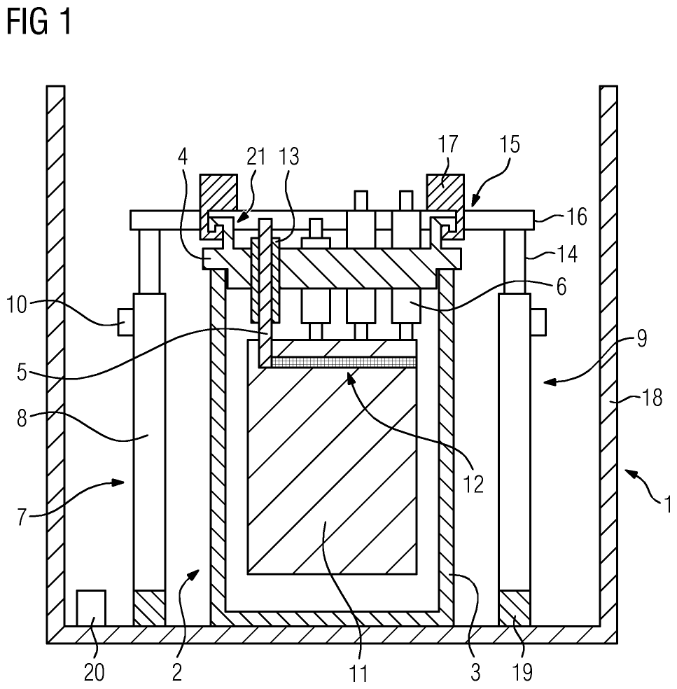

FIG. 1 an embodiment of the transformer arrangement according to embodiments of the present invention,

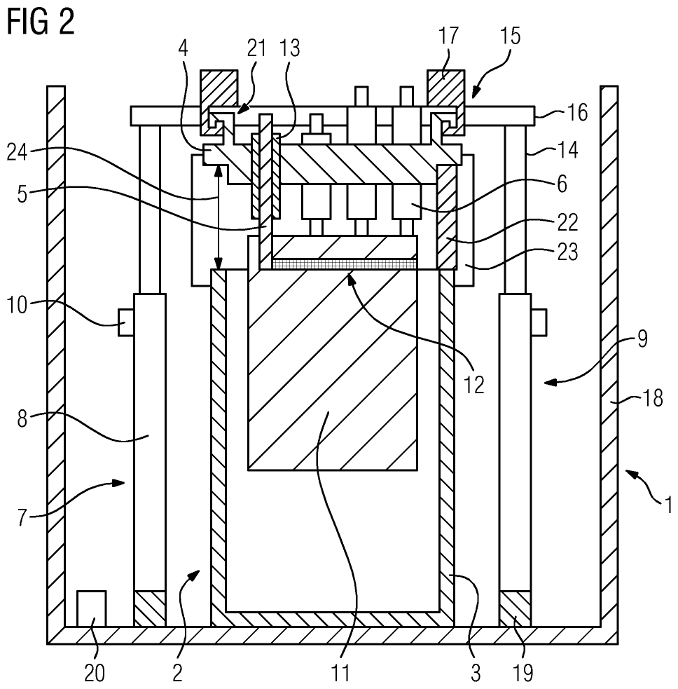

FIG. 2 the transformer arrangement shown in FIG. 1 after the lid is lifted in an embodiment of the method for servicing a transformer according to embodiments of the present invention, and

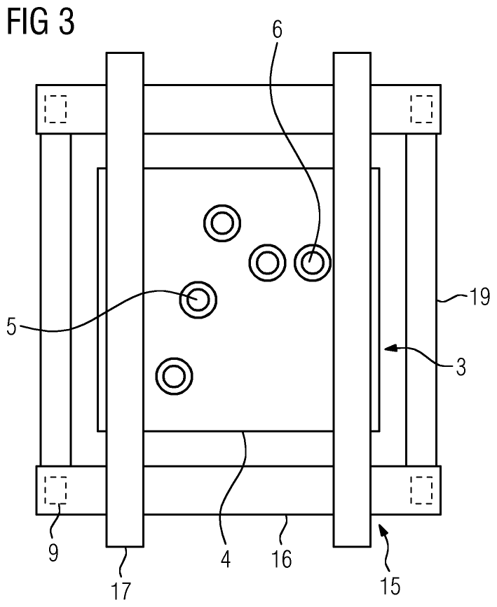

FIG. 3 a top view of the arrangement shown in FIGS. 1 and 2.

### DETAILED DESCRIPTION

FIG. 1 shows a transformer arrangement 1 that can be used in an offshore wind turbine. The transformer arrangement 1 comprises a transformer 2 that comprises a case 3, a lid 4, that closes the case 3 and at least one electrical component 5, 6 that is connected to the lid 4. In the example shown in FIG. 1 the electrical components 5, 6 are high voltage and low voltage bushing rods that connect respective windings 12 to the outside world by passing through the lid 4. The rods can be attached to the lid 4 by an isolation element 13, e.g. a bushing.

The windings 12 are only shown schematically, since the detailed configuration of the core 11 and windings 12 is of limited relevance for the discussed example and multiple possible configurations for the core 11 and the winding 12 are well known in the conventional art. In the example only two high voltage bushing rods, the components 5, and two low voltage bushing rods, the components 6 are shown. E.g. three low voltage bushing rods and four high voltage bushing rods could be used to contact the transformer 2. Also, additional components of the transformer, e.g. vacuum valves to evaluate the interior of the case 3, are not shown. The case 3 can, e.g. be filled by oil or another coolant to cool the core 11 and the windings 12.

The electrical components 5, 6 can be damaged, e.g. by extended use or when a lightning strikes the wind turbine. Exchanging these electrical components 5, 6 is problematic, since it requires access to the interior of the case 3. It would be possible to first remove the coolant from the case 3, then disassemble the case and then access the electrical components 5, 6. This would typically require to remove the transformer from its site of operation and might only be possible onshore.

To allow for an easier access to the electrical components 5, 6, the transformer arrangement 1 comprises a lifting device 7 to lift the lid 4 with respect to the case 3 to expose the electrical components 5, 6 for exchanging or servicing the electrical components. The lifting device 7 comprises fixed components 8, 19 that are fixed with respect to the case 3 and movable components 14, 16, 17 that are coupled to the movement of the lid 4. The movable components 14, 16, 17 are movable with respect to the fixed components 8, 19 by the actuators 10. Both the transformer 2 and the lifting device 7 are fixed to a common carrying structure 18, e.g. a container housing the transformer 2.

The actual lifting is performed by four telescopic bars 9, wherein each of the telescopic bars 9 comprises one of the fixed components 8 and one of the movable components 14. The relative position of the fixed component 8 and the movable component 14 of the telescopic rod 9 can be adjusted by a respective actuator 10. The actuator 10 can be an electrical actuator, e.g. an electric motor, that can be controlled by a control unit 20. The wiring between the actuator 10 and the control unit 20 is not shown. The actuator can, e.g. rotate a cog and the movable component 14 can be equipped with a vertical gear rack and can therefore be vertically shifted by rotating the cog.

When the movable components 14 are moved vertically upward by driving the actuators 10, a lift frame 15 comprising the movable components 16, 17 as orthogonal bars, is also lifted. Since the lid 4 is coupled to the lift frame 15 at at least two positions 21, e.g. by hooks, the lid 4 will be lifted with the lift frame 15.

FIG. 2 shows the same arrangement as FIG. 1 after the telescopic bars 9 were extended by driving the actuators 10. As shown by the arrow 24, the lid 4 is lifted to a certain distance, e.g. at least 300 mm, above the case 3. Therefore, the electrical components 5, 6 are easily accessible and can be exchanged or serviced by the service personal. To avoid a dropping of dirt or equipment into the case 3 and therefore, e.g. into the coolant of the transformer 2, a cover 23 or tarpaulin can be mounted between the case 3 and the lid 4.

While the lifting device 7 already provides a certain redundancy to ensure that the lid 4 cannot accidently drop down back onto the case 3 by using separate actuators to lift the cover 4, additionally redundancy can be added, e.g. by adding at least one blocking element 22 between the case 3 and the lid 4 after the lid 4 is lifted to the desired position.

After servicing and/or exchanging the electrical components 5, 6 that need servicing or exchanging, the cover 23 and the blocking element 22 can be removed and the lid 4 can be lowered back onto the case 3 by providing control signals from the control units 20 to the actuators 10 to contract the telescopic bars 9.

To more clearly show the structure of the transformer arrangement, FIG. 3 shows a top view of the transformer arrangement 1. The fixed component 19 is a frame that surrounds the case 3 of the transformer 2. At four corners of the case 3 the telescopic bars 9 are arranged. The movable component 14 of the telescopic bars 9 and therefore the upper end of the telescopic bars 9 is attached to the movable part 16 and the movable part 16 is coupled to the movable parts 17 to form the lift frame 15. The lift frame 15 is coupled to the lid 4 at at least two positions to allow for an even lifting of the lid 4.

Although the present invention has been disclosed in the form of preferred embodiments and variations thereon, it will be understood that numerous additional modifications and variations could be made thereto without departing from the scope of the invention.

For the sake of clarity, it is to be understood that the use of “a” or “an” throughout this application does not exclude a plurality, and “comprising” does not exclude other steps or elements. The mention of a “unit” or a “module” does not preclude the use of more than one unit or module.

1. A method for servicing a transformer, wherein a lifting device is used to lift a lid that closes a case of a transformer from the case to expose at least one electrical component of the transformer that is connected to the lid for exchanging or servicing the electrical component, wherein the lifting device includes at least one fixed component that is fixed with respect to the case and at least one moveable component that is coupled to the lid, wherein the moveable component is moveable with respect to the fixed component by at least one actuator to lift the lid.

2. The method according to claim 1, wherein a conductive connecting element that is electrically connected to a respective winding of the transformer and passes through the lid is replaced as the electrical component.

3. The method according to claim 1, wherein the lifting device comprises at least one telescopic bar, wherein the lid is lifted by extending the telescopic bar via the actuator.

4. The method according to claim 1, wherein the at least one moveable component is, comprises or forms a lift frame that is coupled to the lid at at least two separate positions.

5. The method according to claim 3, wherein the lifting device comprises at least two or three of the telescopic bars, wherein the lift frame connected to all the telescopic bars.

6. The method according to claim 1, wherein the lid is lifted until the distance between the lid and the case is at least 200 mm.

7. The method according to claim 1, wherein the lid is locked into position after at least one of lifting the lid by a lock and placing at least one blocking element between the lid and the case before the electrical component is exchanged or serviced.

8. The method according to claim 1, wherein the gap between the lid and the case is at least partially covered by a cover or a tarpaulin before the electrical component is exchanged or serviced.

9. A transformer arrangement, comprising a transformer that comprises a case, a lid that closes the case and at least one electrical component that is connected to the lid, characterized in that the arrangement comprises a lifting device to lift the lid with respect to the case to expose the electrical component for exchanging or servicing the electrical components, wherein the lifting device comprises at least one fixed component that is fixed with respect to the case and at least one moveable component that is coupled to the lid, wherein the moveable component is moveable with respect to the fixed component by at least one actuator to lift the lid.

10. The transformer arrangement according to claim 9, wherein the transformer comprises a transformer core with at least two windings and at least one connecting element that is conductively connected to a respective winding and that extends through the lid.

11. The transformer arrangement according to claim 9, wherein the at least one moveable component is, comprises or forms a lift frame that is coupled to the lid at at least two separate positions.

12. The transformer arrangement according to claim 9, wherein the lifting device comprises at least one telescopic bar, wherein the lid is lifted by extending the telescopic bar via the actuator.

13. The transformer arrangement according to claim 11, wherein the lifting device comprises at least two or three of the telescopic bars, wherein the lift frame connected to a respective moveable component of the telescopic bars.

14. The transformer arrangement according to claim 12, wherein the telescopic bars are distributed along a circumference of the case, especially at corners of the case.

15. The transformer arrangement according to claim 12, wherein the fixed components of the telescopic bars are attached to the case or that the fixed components and the case are connected to a common carrying structure.

16. A wind turbine having the transformer as claimed in claim 1.

17. A wind turbine having the transformer as claimed in claim 9.
